(19) United States
(12) Patent Application Publication
(10) Pub. No.: US 2001/0018343 A1
(43) Pub. Date: Aug. 30, 2001

(54) PAGING SERVICE USING BROADCASTING

(75) Inventor: HIROYUKI NAKATA, TOKYO (JP)

Correspondence Address: FRISHAUF HOLTZ GOODMAN LANGER & CHICK, 767 THIRD AVENUE, 25TH FLOOR, NEW YORK, NY, 100172023

(73) Assignee: CASIO COMPUTER CO., LTD.

(21) Appl. No.: 08/952,910

(22) PCT Filed: Mar. 28, 1997
(86) PCT No.: PCT/JP97/01082

§ 371 Date: None

(30) Foreign Application Priority Data
Mar. 29, 1996 (JP) 8-76606
May 16, 1996 (JP) 8-121674

(51) Int. Cl. H04Q 7/20

(52) U.S. Cl. 455/426; 455/45; 455/186.1

(57) ABSTRACT

An FM broadcasting station (5) broadcasts paging ID by multiplexing it on FM broadcasting radio waves in a subframe period assigned in advance to an FM radio receiver 1b (to 1d) to be paged, and broadcasts, as program data, message data directed to the FM radio receiver 1b (to 1d) to be paged. The FM radio receiver 1b (to 1d) repeatedly and intermittently receives the paging ID broadcasted from the FM broadcasting station (5), in the subframe period assigned to itself in advance. When the received paging ID is its paging ID, the FM radio receiver 1b (to 1d) generates an alarm. Thereafter, a user selects a program on which the message data directed to the FM radio receiver 1b (to 1d) to be paged is broadcasted, and views the message data which is the program data displayed, thereby obtaining the message data directed to the FM radio receiver 1b (to 1d).

### TECHNICAL FIELD

The present invention relates to a broadcasting system, a broadcasting apparatus, a broadcast receiver and methods for use in the above system, apparatus and receiver. The present invention is suitable particularly for being applied to an FM broadcasting system, but is not limited thereto.

### BACKGROUND ART

There is recently a service which transmits FM (Frequency Modulation) radio waves with display information such as characters being multiplexed thereon so that the display information is displayed on display means provided on a reception terminal.

This service is known as FM teletext broadcasting, and is practiced as visual information radio.

According to this FM teletext broadcasting, FM broadcasting radio waves, obtained by frequency-multiplexing the display information such as characters and numerals on general audio information, are transmitted from an FM broadcasting station. An FM radio receiver having a display such as a liquid crystal display receives the FM broadcasting radio waves as transmitted, separates the audio information and the display information from each other, and displays the characters corresponding to character codes contained in the display information on the display. This enables a user to view a telecast broadcast which gives service information such as a weather forecast and traffic information, while listening to an FM audio broadcast.

Of late, there is a plan to offer a paging service through utilization of the FM telecast broadcasting, in addition to the service information.

### DISCLOSURE OF INVENTION

It is accordingly an object of the present invention to provide a broadcasting system which can offer the paging service using broadcasting, a broadcasting apparatus, a broadcast receiver and methods for use in the above system, apparatus and receiver, without considerably changing the existing broadcasting system.

According to one preferred embodiment of the present invention, in order to achieve the above object, there is provided a broadcasting system comprising a broadcasting apparatus for broadcasting a plurality of kinds of program information and a plurality of broadcast receivers for receiving and displaying the program information broadcasted from said broadcasting apparatus; the broadcasting apparatus comprising first broadcasting means for broadcasting paging ID information, and second broadcasting means for broadcasting, as at least one of the plurality of kinds of program information, message information directed to at least one of the broadcast receivers; each of the broadcast receivers comprising program selecting means for selecting a desired one of the plurality of kinds of program information broadcasted from the broadcasting apparatus, display means for displaying the program information selected by the program information selecting means, receiving means for receiving the paging ID information broadcasted from the broadcasting apparatus, determining means for determining whether the paging ID information received by the receiving means represents the paging ID of each said broadcast receiver, and paging alarm generating means for generating a paging alarm when the determining means determines that the paging ID information received by the receiving means represents the paging ID of the each broadcast receiver, wherein a user selects, by said program selecting means, a program on which message information directed to the broadcast receiver is broadcasted, and views the message information displayed on the display means, to thereby obtain message information directed to the each broadcast receiver in the message information. The above-described system enables the paging service using broadcasting to be offered without considerably changing the existing broadcasting system.

According to another preferred embodiment of the present invention, there is provided a broadcasting system comprising a broadcasting apparatus for broadcasting a plurality of kinds of program information and a plurality of broadcast receivers for receiving and displaying the program information broadcasted from the broadcasting apparatus; the broadcasting apparatus comprising first broadcasting means for broadcasting paging ID information, and second broadcasting means for broadcasting, as at least one of the plurality of kinds of program information, message information directed to the each broadcast receiver in the message information; each of the broadcast receiver comprising program selecting means for selecting a desired one of the plurality of kinds of program information broadcasted from the broadcasting apparatus, display means for displaying the program information selected by the program information selecting means, receiving means for receiving the broadcasted paging ID information, determining means for determining whether the paging ID information received by the receiving means represents the paging ID of the each broadcast receiver, and obtaining means for obtaining the message information directed to the each broadcast receiver, from the program information of a program on which the message information is broadcasted, when the determining means determines that the paging ID information received by the receiving means represents the paging ID of the broadcast receiver. This system also enables the paging service using broadcasting to be offered without considerably changing the existing broadcasting system.

### BRIEF DESCRIPTION OF DRAWINGS

FIG. 1 is a diagram showing the structure of an FM teletext broadcasting system according to one embodiment of the present invention;

FIG. 2 is a block diagram showing the circuit configuration of an FM radio receiver according to the above embodiment;

FIG. 3 is a diagram showing the circuit configurations of the units, etc. arranged in a service center and an FM broadcasting station according to the above embodiment;

FIG. 4 is a diagram showing the structure of a frame in a transmission format for the FM teletext broadcasting according to the above embodiment;

FIG. 5 is a diagram showing the state wherein the frame in the transmission format for the FM teletext broadcasting according to the above embodiment is divided into a plurality of subframes;

FIG. 6 is a diagram showing the relationship of packet Nos. and the lower four bits of ID with respect to the subframes according to the above embodiment;

FIG. 7 is a diagram showing the bit patterns of block identification codes according to the above embodiment;

FIG. 8A is a diagram showing the structure of a data packet in the transmission format for the FM teletext broadcasting according to the above embodiment;

FIG. 8B is a diagram showing the structure of a prefix in the transmission format for the FM teletext broadcasting according to the above embodiment;

FIG. 9 is a diagram showing the structure of a data group in the case of paging data;

FIG. 10 is a diagram showing the structure of scramble information forming one segment according to the above embodiment;

FIG. 11 is a diagram showing the structure of alternate frequency information forming another segment according to the above embodiment;

FIG. 12 is a diagram showing the structure of paging information forming another segment according to the above embodiment;

FIG. 13 is a diagram showing the structure of a data group in the case of program data (program management data or page data);

FIG. 14 is a diagram showing the structure of the program data according to the above embodiment;

FIGS. 15A and 15B are diagrams showing the structure of the program management data according to the above embodiment;

FIGS. 16A and 16B are diagrams showing the structure of the page data according to the above embodiment;

FIGS. 17A and 17B are diagrams showing the structure of message transmission data according to the above embodiment;

FIG. 18 is a diagram showing the relationship between message reception periods and message transmission periods according to the above embodiment;

FIG. 19 is a flow chart for explaining operations according to the above embodiment;

FIGS. 20A, 20B, 20C, 20D and 20E are timing charts for explaining the aforementioned operations according to the above embodiment;

FIG. 21 is a flow chart for explaining the aforementioned operations according to the above embodiment;

FIG. 22 is a flow chart for explaining other operations according to the above embodiment;

FIG. 23 is a flow chart for explaining the aforementioned other operations according to the above embodiment;

FIG. 24 is a flow chart for explaining the aforementioned other operations according to the above embodiment; and

FIG. 25 is a flow chart for explaining the aforementioned other operations according to the above embodiment.

### BEST MODE FOR CARRYING OUT THE INVENTION

One embodiment of the present invention when being applied to an FM teletext broadcasting system will now be described with reference to the accompanying drawings.

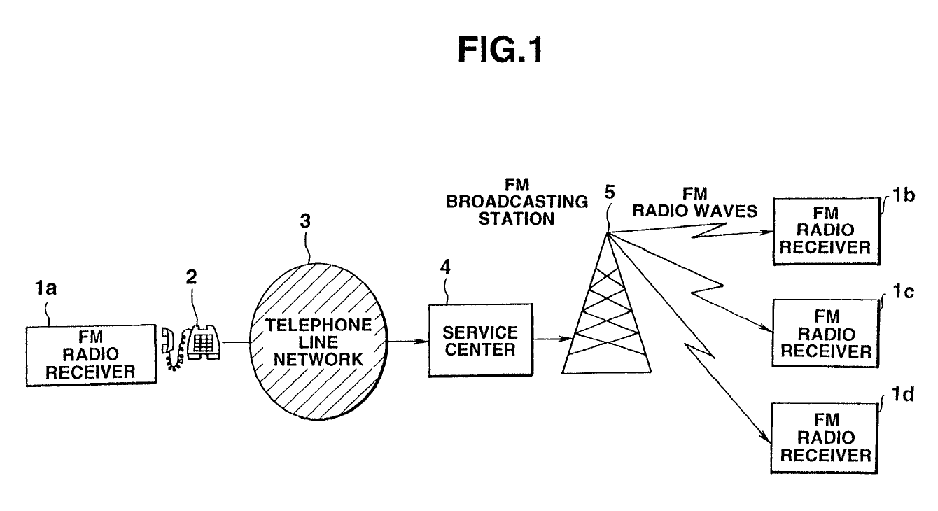

FIG. 1 shows the structure of the entirety of the system. Reference character 1a denotes an FM radio receiver which is going to perform paging. The FM radio receiver 1a has an automatic dialing function in addition to a selective paging receiving function. By bringing a speaker portion of the FM radio receiver 1a into contact with a transmitter of a telephone 2 and by causing the FM radio receiver 1a to output DTMF (Dual Tone Multi Frequency) signals corresponding to a paging number and message data both being input in advance, paging data including the paging number and the message data is transmitted to a service center 4 through a telephone line network 3.

It is possible for the user to request paging by telling the paging number and the message to the service center 4 through the telephone.

The service center 4 transfers the transmitted paging data together with other paging data to an FM broadcasting station 5 entrusted with the paging data transmission, and the FM broadcasting station 5 multiplexes those paging data on FM broadcasting radio waves so as to be broadcasted as multiplexed information.

The FM broadcasting radio waves broadcasted by the FM broadcasting station 5 are received by FM radio receivers 1b to 1d located in a broadcasting area and having the same structure as the above-mentioned FM radio receiver 1a. When the paging number included in the paging data as received by the FM radio receivers 1b to 1d is identical with the paging numbers assigned to the FM radio receivers 1b-1d, those receivers generate paging alarms.

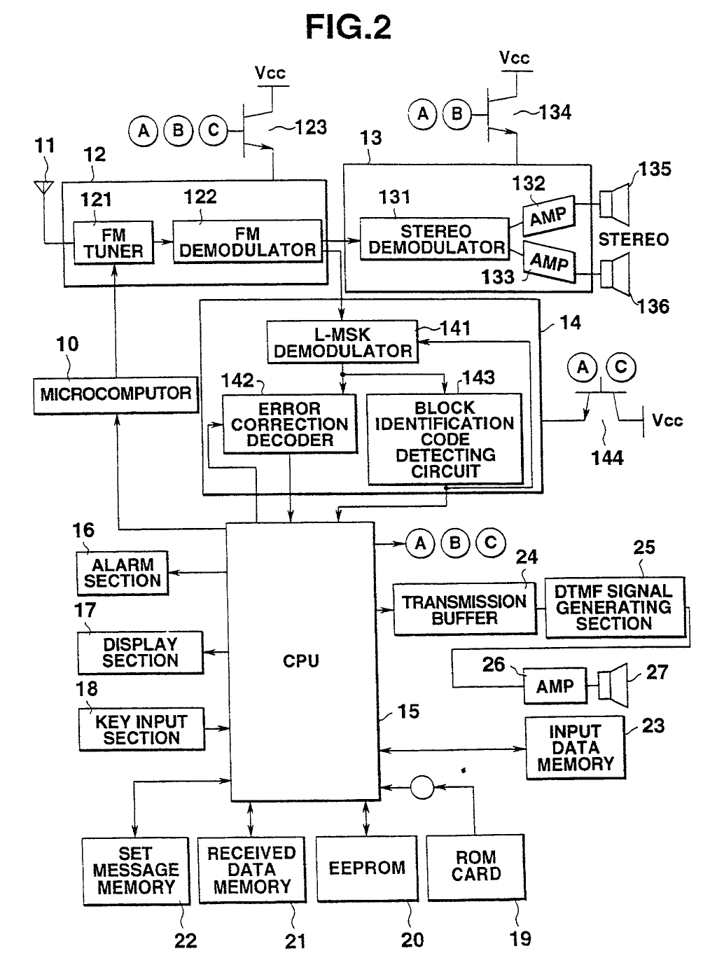

FIG. 2 shows the circuit configuration of the FM radio receiver 1a (to 1d). In this drawing, a receiving section 12 is connected to an antenna 11. The receiving section 12 has an FM tuner 121 and an FM demodulator 122. The FM tuner 121 tunes an FM signal received by the antenna 11. The FM demodulator 122 demodulates the FM signal tuned by the FM tuner 121. A switch 123 is used to turn on/off the supply of electricity to the receiving section 12.

An audio information reproducing section 13 is connected to the FM demodulator 122 of the receiving section 12. The audio information reproducing section 13 has a stereo demodulator 131 and amplifiers 132 and 133. The stereo demodulator 131 separates a stereo signal (an L+R signal and an L−R signal), obtained as a result of the demodulation being performed by the FM demodulator 122, into an L signal and an R signal. The L and R signals are output as stereo sounds from speakers 135 and 136 through the amplifiers 132 and 133, respectively. A switch 132 is used to turn on/off the supply of electricity to the audio information reproducing section 13.

A multiplexed information reproducing section 14 is connected to the FM demodulator 122 of the receiving section 12. The multiplexed information reproducing section 14 has an L-MSK (Level controlled Minimum Shift Keying) demodulator 141, an error correcting decoder 142 and a block identification code detecting circuit 143. The L-MSK demodulator 141 separates, from the FM broadcasting radio waves, the multiplexed information multiplexed thereon by being subjected to such digital modulation that a multiplexing level is changed by 4% to 10% in accordance with the degree of modulation of the stereo difference signal (the L−R signal), and demodulates the separated information. The error correcting decoder 142 corrects any error contained in the multiplexed information demodulated by the L-MSK demodulator 141, and outputs the error-corrected multiplexed information to a CPU (Central Processing Unit) 15. The block identification code detecting circuit 143 detects a block identification code (described later) in the multiplexed information, and outputs the detected block identification code to the CPU 15. A switch 144 is used to turn on/off the supply of electricity to the multiplexed information reproducing section 14.

A microcomputer 10, an alarm section 16, a display section 17, a key input section 18, a ROM (Read Only Memory) card 19, an EPROM (Electric Erasable Program Read Only Memory) 20, a received data memory 21, a set message memory 22, an input data memory 23 and a transmission buffer 24 are connected to the CPU 15.

The microcomputer 10 performs switching of the tuning frequency of the FM tuner 121 in accordance with the operation of a tuning key of the key input section 18. The alarm section 16 alerts via a driving circuit (not shown) that the FM radio receiver 1a (to 1d) is paged. The display section 17 displays messages such as characters sent as the multiplexed information. The key input section 18 is provided with various switches. When any one of the keys of the key input section 18 is operated, a key ON signal according to the key operation is supplied to the CPU 15.

The ROM card 19 stores operation control programs for the CPU 15 and its own paging number (individual ID) in advance. The ROM card 19 is constituted by a magnetic or optical recording medium or a recording medium such as a semiconductor memory. The ROM card 19 is detachably mounted in the body of the FM radio receiver 1a (to 1d). In place of the ROM card 19, a ROM may be immovably provided in the FM radio receiver 1a (to 1d). A program, data, etc. to be recorded on the aforementioned recording medium may be received from another device connected via a communication line or the like. That device connected via the communication line or the like may be provided with a memory unit having the aforementioned recording medium, and the FM radio receiver 1a (to 1d) can utilize the program, the data, etc. stored in that recording medium, through the communication line. The EEPROM 20 stores data used for performing the error correcting operation in the error correcting decoder 142. The received data memory 21 stores, in accordance with a program number, program data transmitted from the FM broadcasting station 5. The set message memory 22 stores set messages in advance in correspondence with set sentence numbers.

The input data memory 23 stores message data such as the set sentence number to be transmitted. The transmission buffer 24 temporarily stores the paging number and the message data to be transmitted, and supplies them to a DTMF signal generating section 25. The DTMF signal generating section 25 generates a DTMF signal corresponding to a signal supplied from the transmission buffer 24, and the DTMF signal generated by the DTMF signal generating section 25 is output from a speaker 27 through an amplifier 26.

The CPU 15 controls the aforementioned circuits collectively in accordance with the operation control programs stored in the ROM card 19.

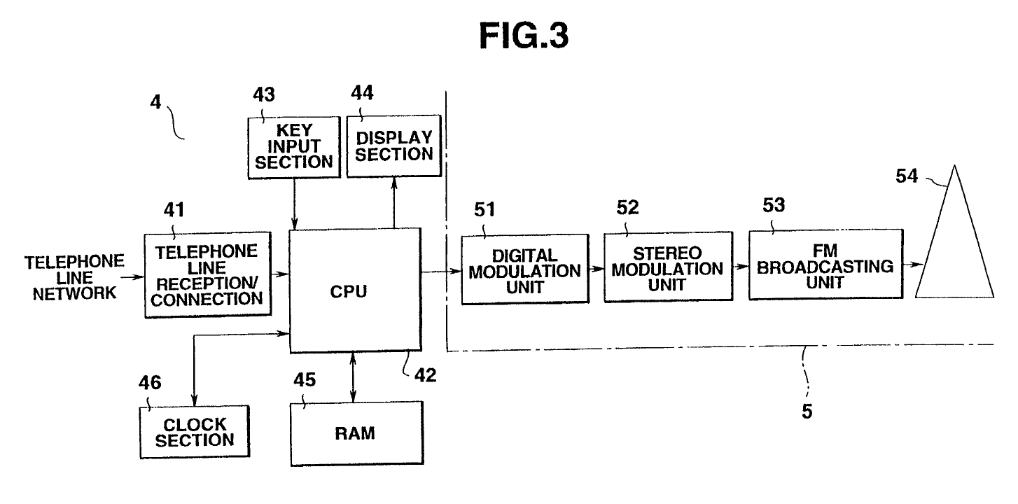

FIG. 3 shows the circuit configurations of the apparatuses installed in the service center 4 and the FM broadcasting station 5. A telephone line reception/connection unit 41 receives the message data supplied in the form of the DTMF signals from the FM radio receiver 1a. The telephone line reception/connection unit 41 encodes the received message data, and supplies it to a CPU 42. The CPU 42 controls the operations of the entire apparatuses installed in the service center 4. Connected to the CPU 42 are a key input section 43 provided with various keys, a display section 44 for displaying the state of the storage of respective data, the data to be transmitted, etc., a RAM (Random Access Memory) 45 having a large capacity and used for storing the paging data transmitted through the telephone line reception/connection unit 41, and a clock section 46 for indicating the current time.

The CPU 42 reads out the paging data stored in the RAM 45, and supplies it to the FM broadcasting station 5.

The CPU 42 in the service center 4 supplies the paging data to a digital modulation unit 51 in the FM broadcasting station 5. The digital modulation unit 51 produces multiplexed information to which an error correction code (a CRC and parity) is affixed, in accordance with a transmission format described later. Furthermore, the digital modulation unit 51 performs L-MSK modulation of the multiplexed information as produced. A stereo modulation unit 52 performs stereo modulation of the audio information (the L signal and the R signal) in order to obtain the L+R signal and the L−R signal, and affixes the L-MSK modulated multiplexed information to the stereo-modulated audio information. An FM broadcasting unit 53 performs frequency modulation of the information (signal) obtained as a result of the addition being performed by the stereo modulation unit 52, and transmits the frequency-modulated information from an antenna 54 as FM broadcasting radio waves.

A part or the entirety of the processing performed by the service center 4 may be carried out by the FM broadcasting station 5.

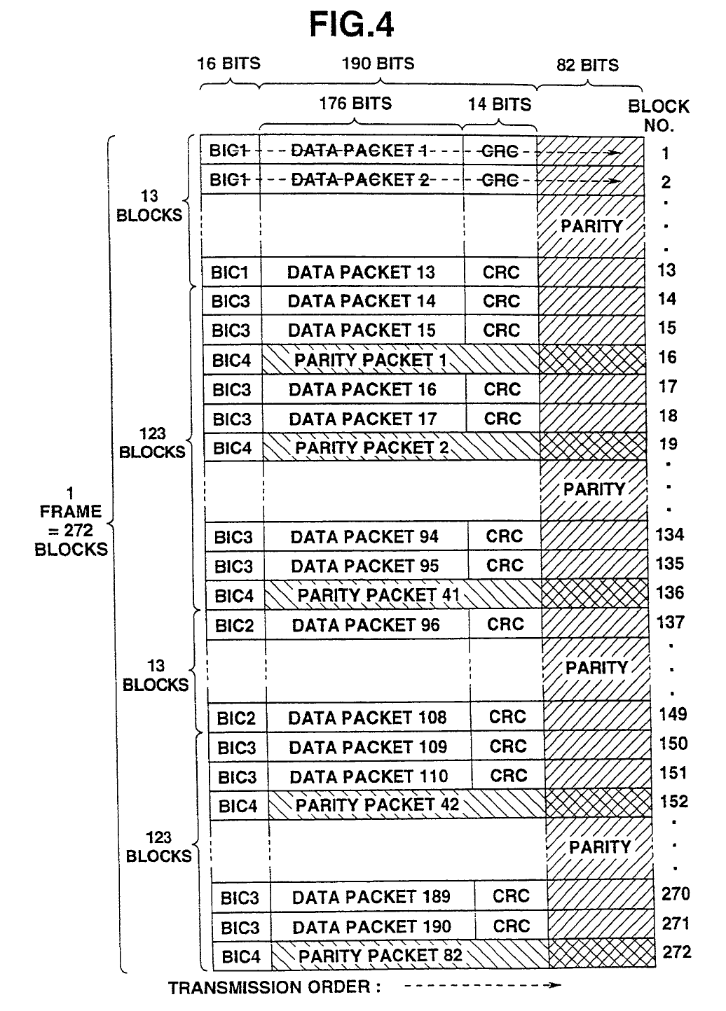

FIG. 4 shows the structure of 1 frame of the multiplexed information transmitted from the FM broadcasting station 5. 1 frame is constituted by 272 blocks. A 16-bit BIC (Block Identification Code) for enabling block synchronization and frame synchronization is affixed to the head of each block.

Of the 272 blocks, 190 blocks are used as data packets for the transmission of data such as the paging data and the program data, while 82 blocks are used as parity packets for the transmission of parities (vertical parities) which are arranged in a column direction. In actual fact, however, the 82 parity packets indicate the parities of all data packets which are arranged in the column direction, and are distributed as shown in FIG. 4 in order to cope with a burst error.

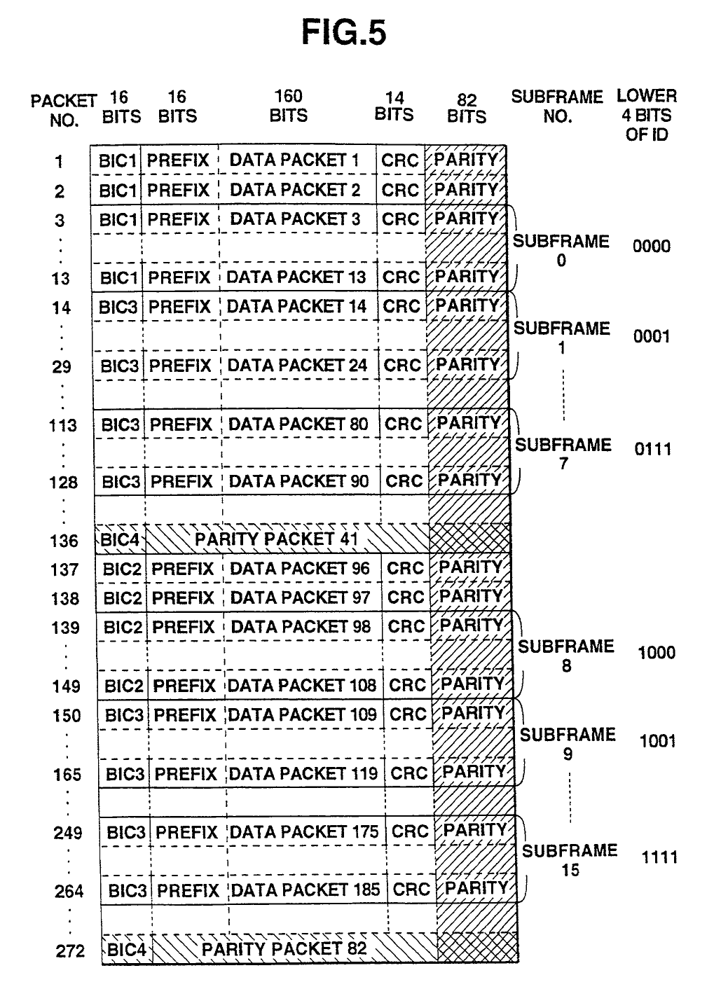

In this embodiment, as shown in FIG. 5, 1 frame includes 16 subframes for the sake of the selective paging service. In this case, the first half of the frame ends at parity packet No. 136. A subframe 0 includes the data packets (BICs 1 described later) of packets Nos. 3 to 13, while a subframe 2 includes the data packets (BICs 3 described later) of packets Nos. 14 to 29, and similarly a subframe 7 includes the data packets (the BICs 3) of packets Nos. 113 to 128. The second half of the frame starts at the data packet of packet No. 137. A subframe 8 includes the data packets (BICs 2 described later) of packets Nos. 139 to 149, while a subframe 9 includes the data packets (the BICs 3) of packets Nos. 150 to 165, and similarly a subframe 15 includes the data packets (the BICs 3) of packets Nos. 249 to 264.

Each of the subframes Nos. 0 to 15 corresponds to data of the lower four bits (the lower fourth bit to the first bit) of one of (28-bit) paging ID codes serving as the paging numbers assigned to the FM radio receivers 1a to 1d. In other words, the FM radio receivers 1a to 1d belong each to any one of 16 groups divided in accordance with the data of the lower four bits of their own ID codes, and each radio receiver can intermittently receive any subframe corresponding to the group to which it belongs.

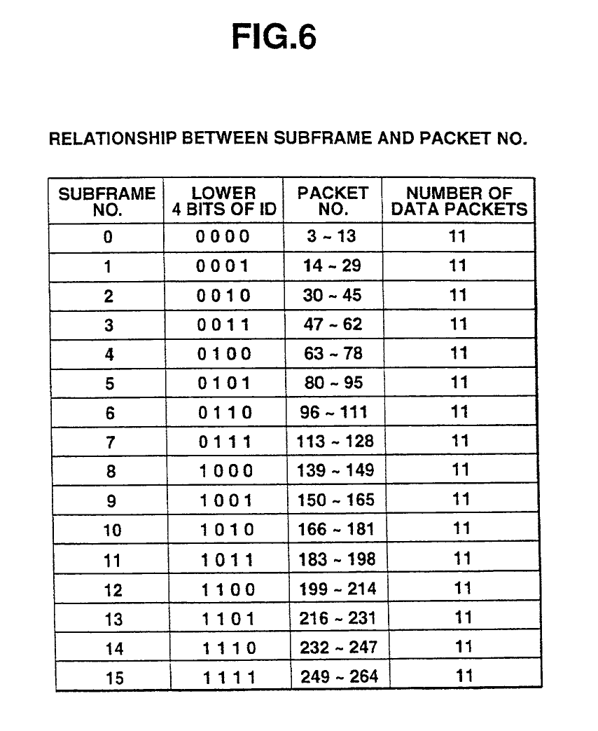

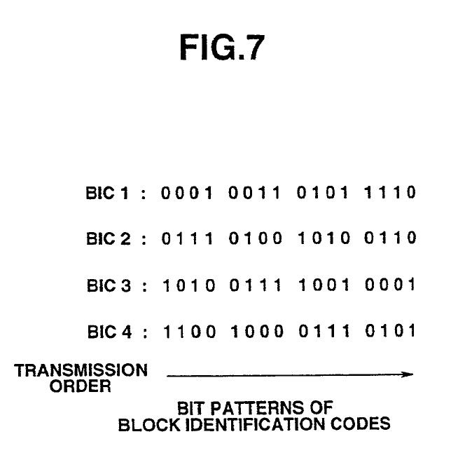

FIG. 6 shows the relationship of packet Nos. and the lower four bits of the ID codes with respect to the subframe numbers 0 to 15. FIG. 7 shows the bit patterns of 16-bit BICs at the heads of the respective blocks. As shown in FIG. 5, the timing of switching from one packet to another packet, the timing of the end of a frame, and the timing of the start of a new frame can be understood from the timing at which changes occur in the BICs.

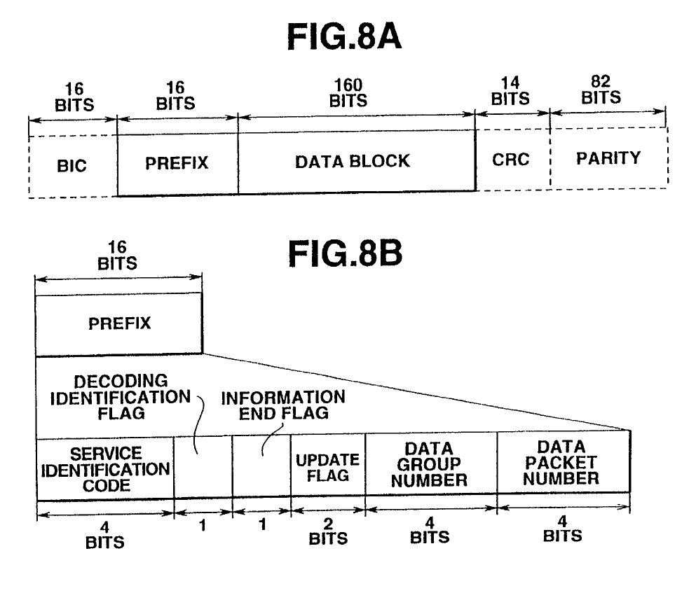

In the case of additional information such as paging information, each of the data packets included in a frame consists of 176-bit data, a 14-bit CRC (Cyclic Redundancy Code) and an 82-bit parity, the 176-bit data being constituted by a 16-bit prefix and a 160-bit data block, as shown in FIG. 8A.

The 16-bit prefix is constituted by a 4-bit service identification code, a 1-bit decoding identification flag, a 1-bit information end flag, a 2-bit update flag, a 4-bit data group number and a 4-bit data packet number.

The 4-bit service identification code located at the head of the prefix is used to identify the contents of data in a data packet. A service identification code “0011” indicates a data packet for the paging information, while service identification codes “1000”, “0100”, “1100” and “0010” indicate data packets for program data such as characters, a drawing and traffic information.

The 1-bit decoding identification flag represents “1” when an error-corrected output should be generated immediately after decoding only in a horizontal direction, and represents “0” when such an output should be generated after decoding in the horizontal and vertical directions. In a radio wave paging mode described later, the FM radio receivers intermittently receive only the subframes assigned to themselves for the purpose of saving the battery power, under which condition the decoding identification flag represents “1”. The 1-bit information end flag represents “1” when a data group to be transmitted in accordance with a given group number ends, and represents “0” in other cases. The 2-bit update flag is incremented by 1 when the contents of data in a data group to be transmitted in accordance with a given group number are updated. When the contents of the data in the data group are not updated, the update flag represents the same value as that of the previously transmitted update flag.

The 4-bit data group number indicates the number assigned to a data group when that group is transmitted. In the case where the service identification code represents “0011” indicating a data packet for the paging information, the data group number is set at the lower four bits of one of the above-described paging ID codes. A plurality of such data group numbers are predetermined in correspondence with the subframe numbers so that the FM radio receivers 1a to 1d can perform intermittent reception.

The 4-bit data packet number indicates the numbers from 0 which are assigned to the data packets included in a data group to be transmitted.

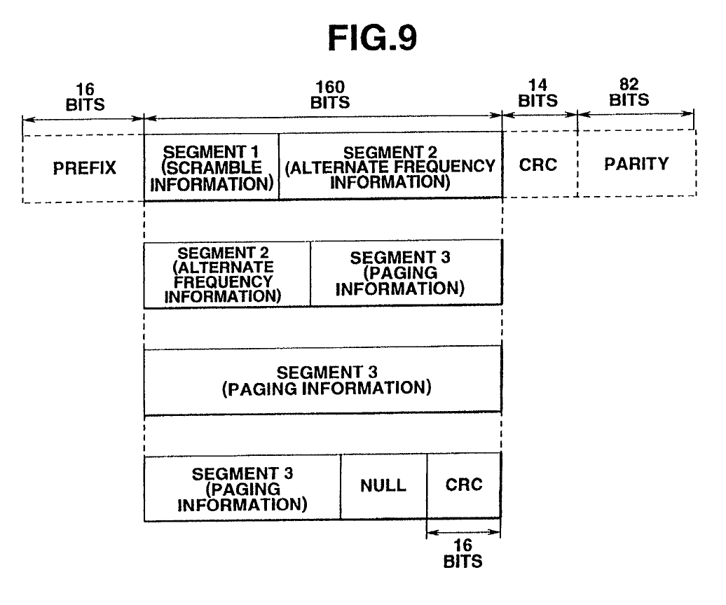

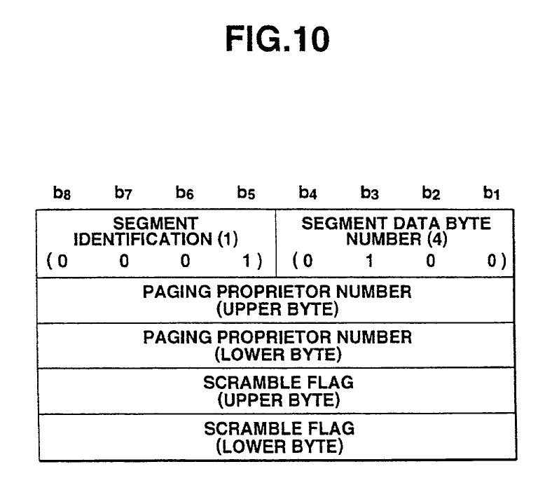

In the case of the paging data, as shown in FIG. 8A, the data group consists of one or a plurality of 160-bit data blocks each including a segment 1 (the scramble information), a segment 2 (the alternate frequency information) and a segment 3 (the paging information) as shown in FIG. 9. NULL is data inserted in a redundant portion. All data in the segments 1 to 3 are not necessarily transmitted, and one or two of them may be transmitted. The transmission intervals of the data in the segments 1 and 2 are especially long.

The segment 1 (the scramble information) consists of 4-bit segment identification, a 4-bit segment data byte number, a 2-byte paging proprietor number and a 2-byte scramble flag. In this case, the segment identification is set at “0001” indicating the scramble information. The segment data byte number is fixed at “0100” (i.e., 5 in the decimal system). The paging proprietor number is a flag for identifying a paging proprietor, while the scramble flag is the information necessary for descrambling.

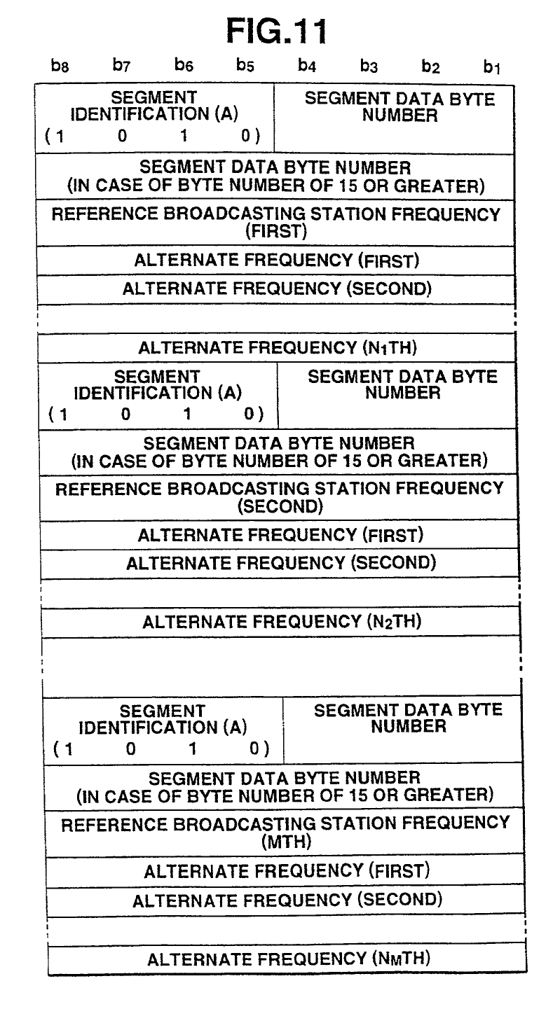

As shown in FIG. 11, the segment 2 (the alternate frequency information) consists of 4-bit segment identification, a 4-bit (or 4 bits+1 byte) segment data byte number indicating the number of bytes of segment data, a 1-byte reference broadcasting station frequency and (first to Nth) N-byte alternate frequencies. In this case, the segment identification is set at “1011” indicating that it is the alternate frequency information. These 4 bits are employed when the number of bytes of the segment data is 14 or less. When the number of bytes of the segment data is 15 or greater, “1111” is set in a first “segment data byte number” area of 4 bits, and data representing the number of bytes of the segment data is set in the next “segment data byte number” area of 1 byte. The reference broadcasting station frequency indicates the frequency of the reference broadcasting station and that of its relay broadcasting station. The alternate frequency information indicates the frequency of an adjacent broadcasting station which is to be subjected to the AF (Automatic Frequency) control performed by the reference broadcasting station. The adjacent broadcasting station performs the same paging service as that of the reference broadcasting station.

An M-number of segments 2 (the alternate frequency information) are prepared.

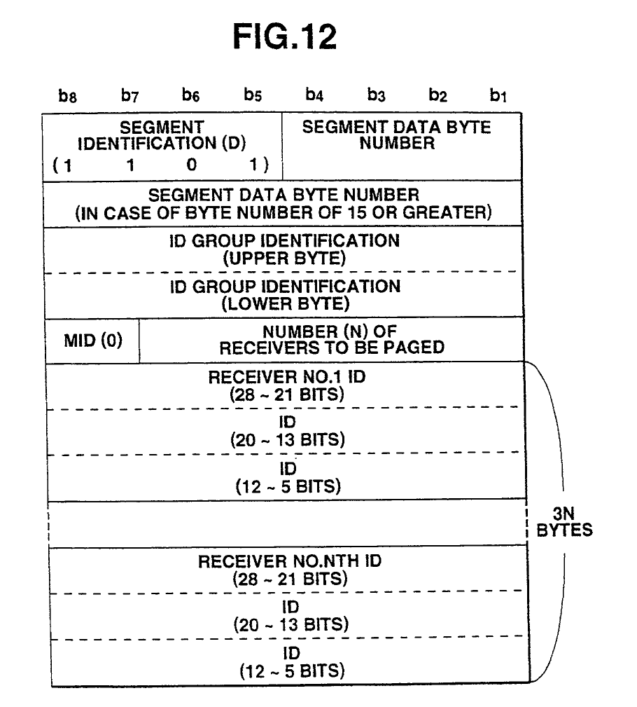

As shown in FIG. 12, the segment 3 (the paging information) consists of 4-bit segment identification, a 4-bit (or 4 bits+1 byte) segment data byte number, 2-byte ID group identification, a 2-bit identification code (MID), a 6-bit paged receiver number representing the number of FM radio receivers to be paged, and an individual-paging data group. In this case, the segment identification is set at “1101” indicating the paging information. Those 4 bits are employed when the number of bytes of the segment data byte is 14 or less. When the number of bytes of the segment data is 15 or greater, “1111” is set in the first “segment data byte number” area of 4 bits, and data representing the segment data byte number is set in the next “segment data byte number” area of 1 byte.

The ID group identification is constituted by 16-bit flag data. The FM radio receivers 1a to 1d, each of which belongs to one of the groups according to the lower four bits of the ID codes, are further divided in 16 groups in accordance with the lower eighth to fifth bits of the ID codes. Any one of the bits constituting the ID group identification flag data represents “1”. This shows that any one of the FM radio receivers 1a to 1d which belongs to the group corresponding to the bit representing “1” is paged. For example, in the case of b5 (in the upper byte)=1, any one of the FM radio receivers which has an ID code whose lower eighth to fifth bits are “0101” (i.e., 5 in the decimal system) is paged.

The identification code MID (0) indicates that individual-paging ID is written. The value of N indicates the number of FM radio receivers to be paged individually. The individual-paging data group is constituted by first to Nth individual-paging data consisting of the upper twenty-four bits (the 28th to 5th bits) of the ID codes of the FM radio receivers to be paged.

In the case of simultaneous paging [an identification code MID (2)] which will be described later, all of the bits constituting the ID group identification code represent “1”.

In the case of the program data such as message board program data which will be described later, each of the data packets in a frame consists of 176-bit data, a 14-bit CRC and 82-bit parity, the 176-bit data being constituted by a 32-bit prefix and a 144-bit data block.

As regards the structure of the prefix in the case of the program data, a detailed explanation will not be made since it is identical with that of the prefix in the case of the additional information, except that there is a difference in the number of bits.

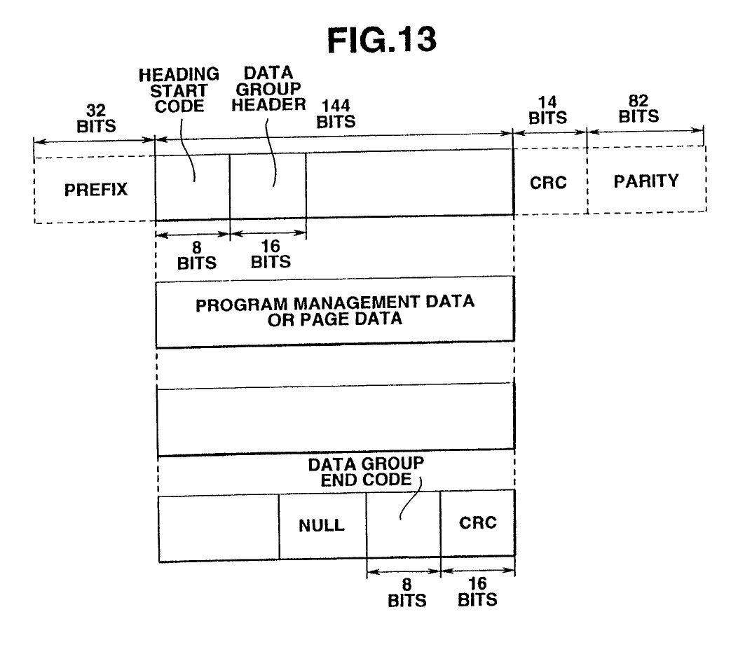

FIG. 13 shows the case where a data group is constituted not by the 160-bit data block(s) shown in FIG. 8A but by one or a plurality of 144-bit data blocks, and is used as the program management data or the page data in the program data. The data group, which is composed of the 144-bit data block/blocks, includes a heading start code, a data group header, the program management data or the page data, and a data group end code. Each of the heading start code and the data group end code is constituted by 8 bits, and NULL is the data inserted in a redundant portion.

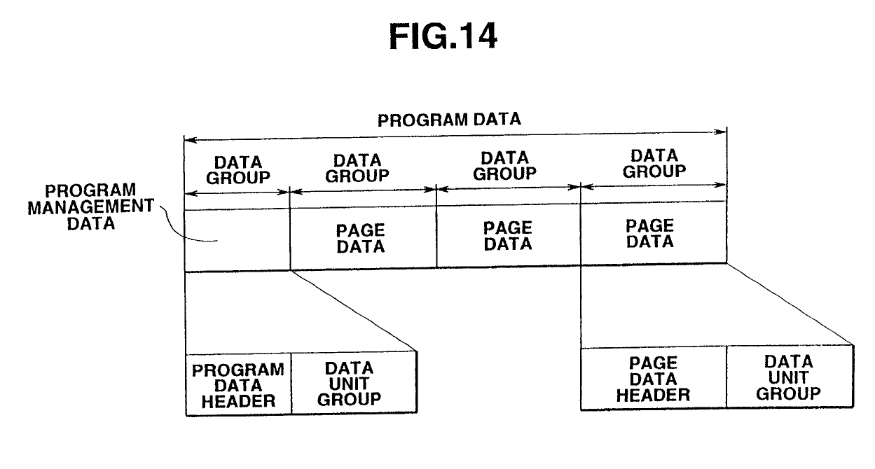

FIG. 14 shows the structure of the program data consisting of the aforementioned program management data and one or a plurality of page data items.

The aforementioned program management data consists of a program data header serving as the header of the program management data and a data unit group.

Moreover, the above-described page data consists of a page data header serving the header of the page data and a data unit group.

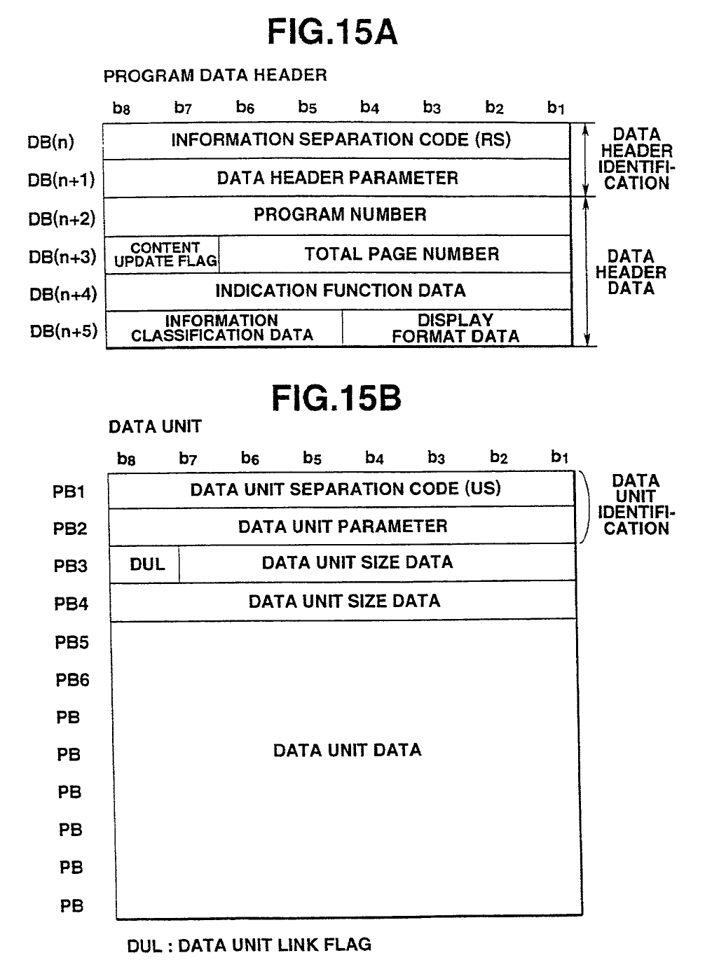

FIG. 15A shows the structure of the program data header. This header consists of data header identification of 2 bytes and data header data of 4 bytes. The data header identification is constituted by an information separation code (RS) of 8 bits and a data header parameter of 8 bits, while the data header data is constituted by a program number of 8 bits, a program content update flag of 2 bits indicating updating in units of programs, a total page number of 6 bits representing the total number of pages forming a program, indication function data of 8 bits indicating the type of a code included in the program, information classification data of 4 bits for identifying the information classification of the contents of the program, and display format data of 4 bits for designating a display mode.

FIG. 15B shows the structure of each of the data units forming the data unit group. Each data unit is constituted by data unit identification of 2 bytes, a data unit link flag (DUL) of 1 bit indicating the linking of data units, data unit size data of 15 bits representing the byte length of data unit data, and the data unit data of at most 32,767 bytes. The data unit identification is constituted by a data unit separation code (RS) of 8 bits and a data unit parameter of 8 bits.

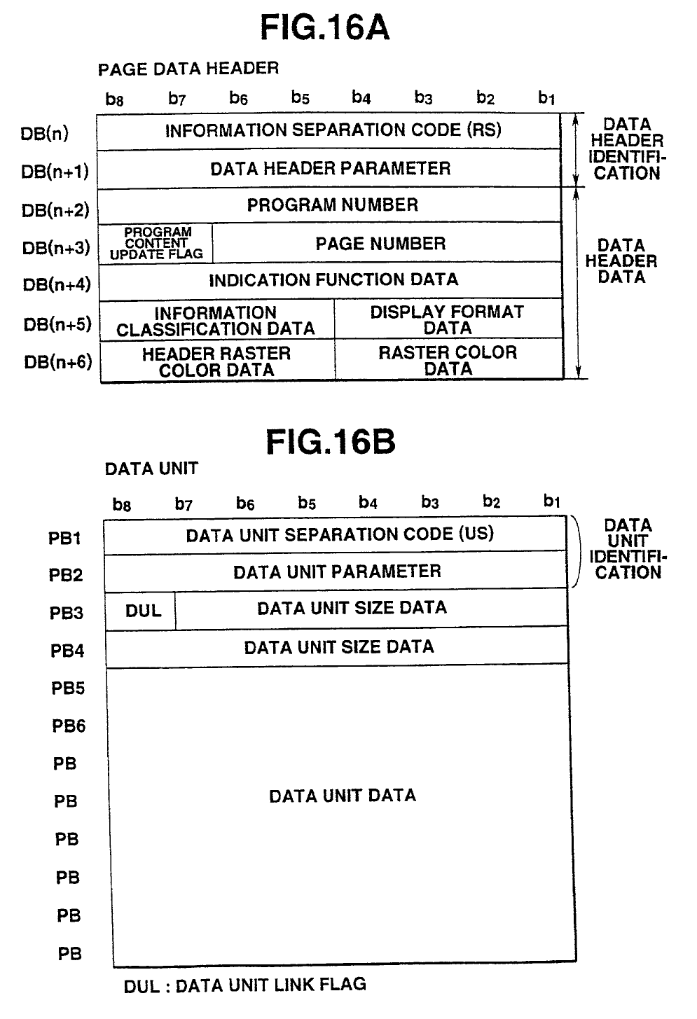

FIG. 16A shows the structure of the page data header. This header is constituted by 7 bytes in total, i.e., 2-byte data header identification and 5-byte data header data. The 2-byte data header identification consists of the information separation code (US) of 8 bits and the data header parameter of 8 bits, while the 5-byte data header data consists of a program number of 8 bits, a page content update flag of 2 bits indicating updating of contents of each page, a program page number of 6 bits, indication function data of 8 bits indicating the type of a character included in a page, information classification data of 4 bits for identifying the information classification of the page contents, display format data of 4 bits for designating the display mode, header raster color data of 4 bits representing the color of the raster of a header sentence display area in the form of a lower address in a color map, and raster color data of 4 bits representing the color of the raster of a text display area in the form of a lower address in the color map.

FIG. 16B shows the structure of each of the data units forming the data unit group. This structure is identical with that shown in FIG. 15B.

The structure of message transmission data will now be explained. The message transmission data is transmitted as the data unit data in the data unit group included in the above-described page data, irrespective of the presence/absence of ID.

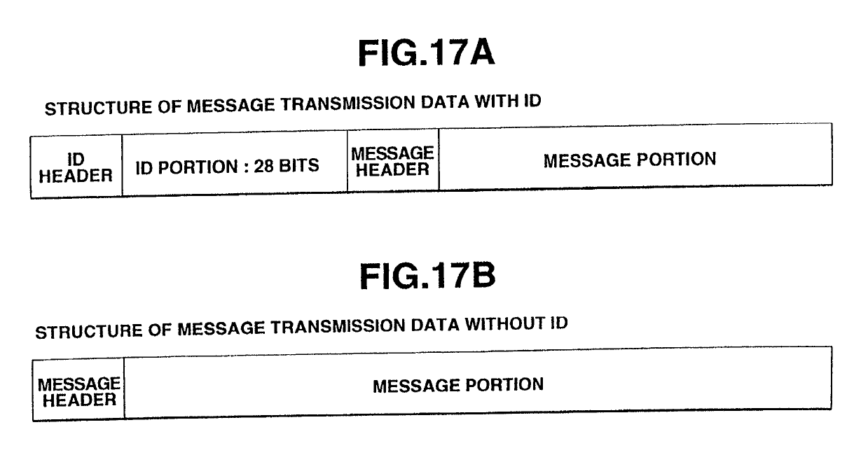

FIG. 17A shows the structure of the message transmission data in the case of the presence of ID, in other words, when individually paging the FM radio receivers. In this case, the message transmission data consists of an ID header, an ID portion of 28 bits indicating the ID number of the FM radio receiver to be paged, a message header and a message portion.

In contrast, FIG. 17B shows the structure of the message transmission data in the case of the absence of ID, in other words, when simultaneously paging all of the FM radio receivers. In this case, the message transmission data consists of the message header and the message portion.

No ID may be affixed to the message data in the case of individual paging, and such message data can be transmitted as message data without ID.

The operation of the present invention according to this embodiment will now be described.

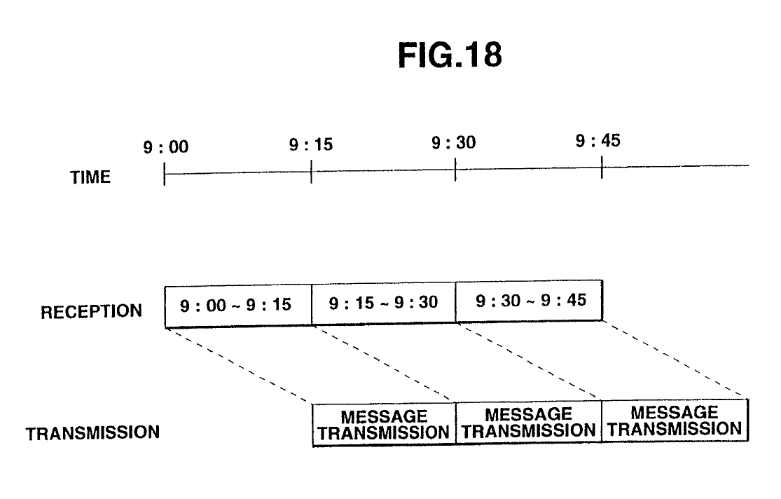

FIG. 18 shows the case where the service center 4 receives, through the telephone 2 and the telephone line network 3, paging data serving as the DTMF signal according to the paging number and the message data from the FM radio receiver 1a which is going to perform paging, and transfers the paging data to the FM broadcasting station 5 together with other paging data. The FM broadcasting station 5 multiplexes those paging data as multiplexed information on FM broadcasting radio waves so as to be repeatedly output and broadcasted.

For example, the paging data received by the service center 4 during the period of time from 9:00 to 9:15 is repeatedly transmitted in the aforementioned data format during the period of time from 9:15 to 9:30 in the period of the subframe corresponding to the ID (the paging number as received) designating the FM radio receiver to be paged. In short, the received message data is repeatedly transmitted in the aforementioned data format.

By prolonging the transmission period, the number of times of retransmission is increased. This increases the possibility that even if the FM radio receiver cannot receive the message data once depending on the receiving conditions, it can receive the message data next time et seq.

The FM broadcasting station 5 not only can transmit the paging data received by the service center 4 from a user, but also can send a message to a listener who has sent a request to the FM broadcasting station 5, by transmitting the individual-paging ID data and the message data.

The operations of the FM radio receivers 1b to receives such a broadest will now be described.

In the case of listening to an ordinary FM broadcast from the FM radio receivers 1b to 1d, the receiving section 12 and the audio information reproducing section 13 are turned on as commanded by the CPU 15 in accordance with the key operation of the key input section 18. In this case, the CPU 15 sets a signal on control line (B) active to turn on the switches 123 and 134.

When the antenna 11 receives FM broadcasting radio waves under the above-described condition, the FM tuner 121 tunes the FM radio waves, and thereafter the FM demodulator 122 demodulates the FM signal. The stereo demodulating section 131 demodulates the stereo signal (the L+R signal and the L−R signal), i.e., the demodulated signal supplied from the FM demodulator 122, in order to obtain the L signal and the R signal. The L and R signals demodulated by the stereo demodulating section 13 are output from the speakers 135 and 136 through the amplifier 132 and 133, respectively.

In the case of listening to an ordinary FM broadcast from the FM radio receivers 1b and 1d and viewing an FM teletext broadcast on the FM radio receivers 1b and 1d, the receiving section 12, the audio information reproducing section 13 and the multiplexed information reproducing section 14 are all turned on as commanded by the CPU 15 in accordance with the key operation of the key input section 18. The CPU 15 sets a signal on control line (A) active to turn on the switches 123, 134 and 144.

In this case, while the above-described audio information is being received, the L-MSK demodulator 141 separates and demodulates a multiplexed signal. After being subjected to the error correcting operation performed by the error correcting decoder 142, the multiplexed signal is displayed as character information on the display section as commanded by the CPU 15.

In the case of viewing an FM teletext broadcast, the receiving section 12 and the multiplexed information reproducing section 14 are turned on. The CPU 15 sets a signal on control line (C) active to turn on the switches 123 and 144.

When the radio wave paging mode is designated, the CPU 15 outputs a battery saving signal through on the control line (C).

As will be described later, the CPU 15 sets the battery saving signal active to turn on the switches 123 and 144 in accordance with the timing of the start of the transmission period in which the subframe of the FM radio receiver 1b (to 1d) is transmitted. The CPU 15 sets the battery saving signal inactive to turn off the switches 123 an 144 in accordance with the timing of the end of the above-mentioned transmission period. Thus, the CPU 15 receives the subframe intermittently.

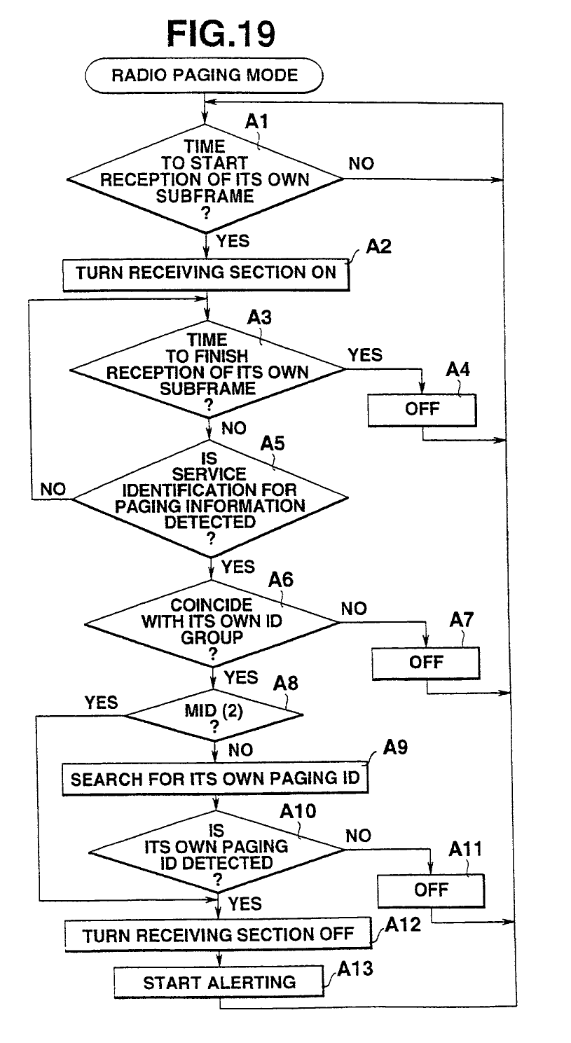

The processing when the radio wave paging mode is designated will now be described with reference to the flow chart shown in FIG. 19.

The FM radio receivers 1b to 1d belong each to any one of the 16 groups divided in accordance with the lower four bits of their own ID codes. Each of the FM radio receivers 1b to 1d can intermittently receive any subframe assigned to the group to which it belongs.

The processing shown in the flowchart starts upon designation of the radio wave paging mode.

When the processing starts, determination is performed as to whether it is time for the FM radio receiver 1b (to 1d) to start receiving a subframe of its own (step A1). When it is determined in step A1 that it is not time to start receiving such a subframe, step A1 is repeated, while the FM radio receiver 1b (to 1d) waits for the time to receive such a subframe. When it is determined in step A1 that it is time to start receiving such a subframe, the receiving section 12 and the multiplexed information reproducing section 4 are turned on as commanded by the CPU 15 (step A2).

Next, determination is performed as to whether it is time to end the reception of the subframe (step A3). When it is determined in step A3 that it is not time to end the reception of the subframe, it is determined whether the 4-bit service identification code in the prefix of FIG. 8B, which is included in a data packet in the subframe, is that for the paging information (step A5). When it is determined in step A5 that the 4-bit service identification code is not that for the paging information, the flow of the processing returns to step A3, and the determining steps A3 and A5 are repeated.

When it is determined in step A3 that it is time to finish receiving the subframe, the receiving section 12 and the multiplexed information reproducing section 14 are turned off as commanded by the CPU 15 (step A4). The flow of the processing returns to step A1, and the FM radio receiver 1b (to 1d) waits for the time to start receiving the next subframe of its own.

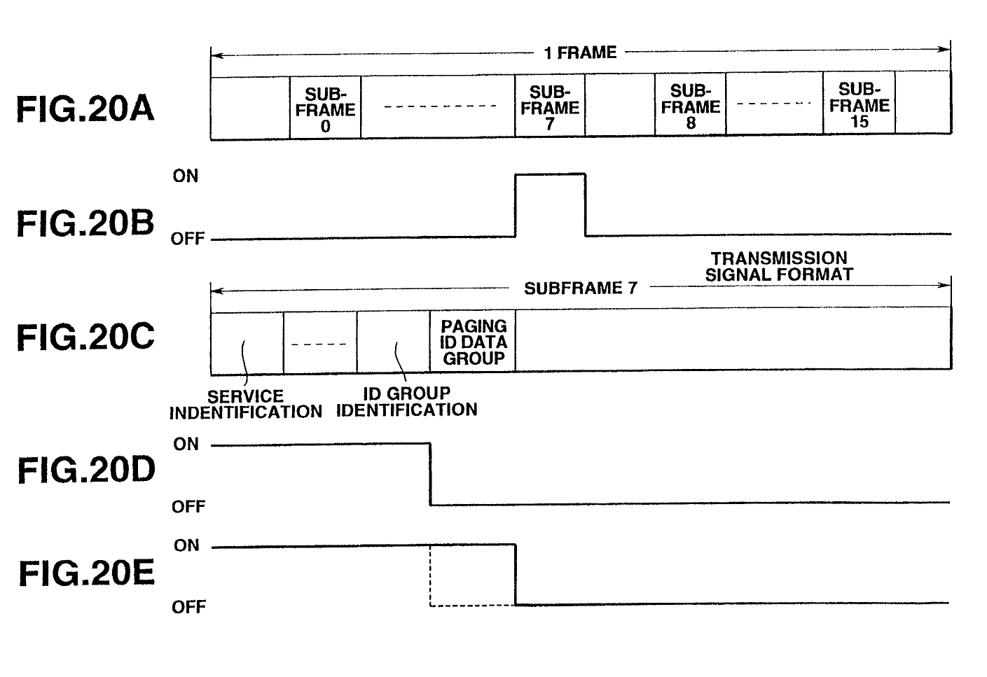

In this case, the receiving section 12 and the multiplexed information reproducing section 14 are turned on as shown in FIG. 20B at the timing of the start of the reception of a subframe which is, for example, a subframe 7 in the frame shown in FIG. 20A. When, however, the service identification code for the paging information is not detected in the subframe, the receiving section 12 and the multiplexed information reproducing section 14 are turned off at the timing of the end of the reception of the subframe.

When it is determined in step A5 that the service identification code for the paging information is detected in the subframe, a reference is immediately made to the paging data of FIG. 9 which is included in the data packet in the subframe, and it is determined whether the bit corresponding to the ID number included in the ID group identification code in the paging information of FIG. 12 represents the value “1” (step A6).

In the case where it is determined in step A6 that the bit does not represent “1”, the receiving section 12 and the multiplexed information reproducing section 14 are immediately turned off as commanded by the CPU 15 (step A7). The flow of the processing returns to step A1, and the FM radio receivers 1b (to 1d) waits for the time to start receiving the next subframe of its own.

In this case, when the bit corresponding to the ID number included in the ID group identification code does not represent “1” in the transmission format of the subframe 7 shown in FIG. 20C, the receiving section 12 and the multiplexed information reproducing section 14 are immediately turned off, as shown in FIG. 20D.

When the bit corresponding to the ID number in the ID group identification code is determined to represent “1” in step A6, it is determined whether the received ID code (MID), i.e., a 2-bit identification code, represents in the decimal system the value “2” (equal to “10” in the binary system) which indicates the simultaneous paging (step A8).

When it is determined in step A8 that the MID does not represent “2”, the value of the MID is “0” which indicates the individual paging. Then, the FM radio receiver 1b (to 1d) searches individual-paging ID No. 1 to No. N of FIG. 12 for its own paging ID (step A9).

Next, it is determined whether its own paging ID is detected as a result of the search (step A10). When it is determined that such paging ID is not detected, the receiving section 12 and the multiplexed information reproducing section 14 are immediately turned off as commanded by the CPU 15 (step A11). The flow of the processing returns to step A1, and the FM radio receiver 1b (to 1d) waits for the time to start receiving the next subframe of its own.

In this case, when such paging ID is not detected as a result of the search of the paging ID data group in the transmission format of the subframe 7 shown in FIG. 20C, the receiving section 12 and the multiplexed information reproducing section 14 are immediately turned off.

When it is determined in step A10 that such paging ID is detected, or when it is determined in step A8 that the 2-bit identification code MID represents in the decimal system the value “2” indicating the simultaneous paging, the receiving section 12 and the multiplexed information reproducing section 14 are turned off in step A12, and thereafter the CPU 15 drives the alarm section 16 such that it sounds an alarm, thus starting alerting that the FM radio receiver 1b (to 1d) is paged (step A13). After this, the flow of the processing returns to step A1, and the FM radio receiver 1b (to 1d) waits for the time to start receiving the next subframe of its own.

When the 2-bit identification code MID indicating the simultaneous paging is received subsequent to the ID group identification code in the transmission format of the subframe 7 shown in FIG. 20C, the individual-paging ID is not transmitted. Consequently, as shown by a broken line in FIG. 20E, the receiving section 12 and the multiplexed information reproducing section 14 are immediately turned off as commanded by the CPU 15 (step A12), without performing the processing of steps A9 and A10, and the generation of a paging alarm is initiated (step A13).

Employing this method, a message which is desired to be positively given to the user of the FM radio receiver 1b (to 1d), such as news or emergency information from the service center 4 or the FM broadcasting station 5, can be transmitted at the time of the simultaneous paging.

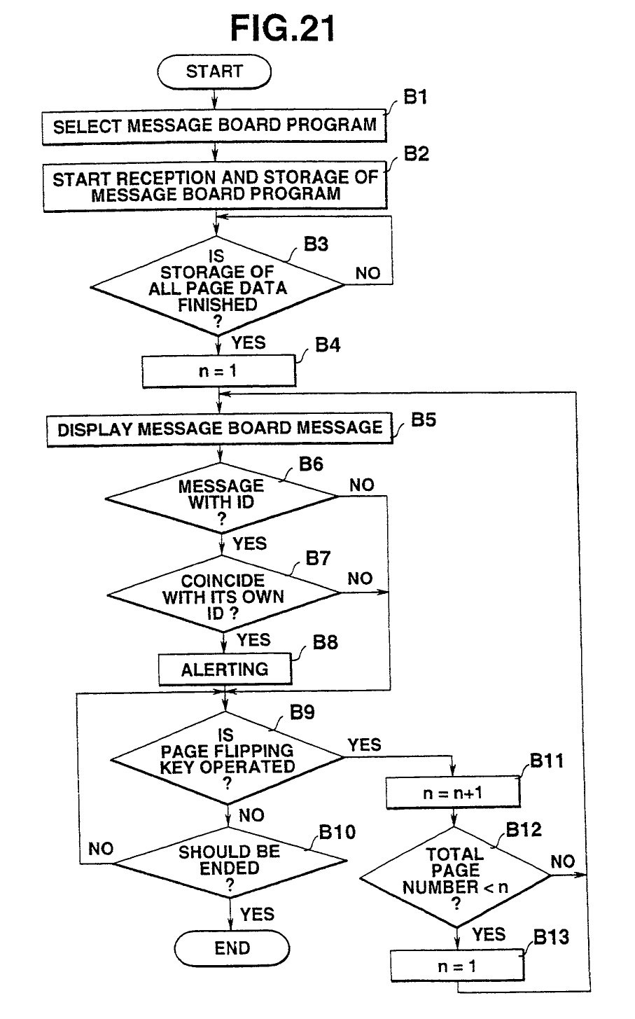

Upon the start of the generation of the paging alarm in step A13, the user of the FM radio receiver 1b (to 1d) operates a key on the key input section 18 in order to cause the message transmitted to him/her to be displayed, whereby the radio paging mode is canceled, and the message displaying operation shown in the flowchart of FIG. 21 is initiated.

In FIG. 21, menu selection is performed among a variety of FM teletext broadcasting programs by the user's operation of a key of the key input section 18, whereby a message board program on which paging message data is to be broadcasted is selected (step B1).

Following the above, the reception and storage of the message board program as selected are initiated (step B2) and are continued until it is determined in step B3 that all page data of the message board program are completely stored in the received data memory 21.

When it is determined in step B3 that all page data are completely stored, a variable n for designating the page to be displayed is set at the initial value “1” in a predetermined area within a register (not shown) included in the CPU 15 (step B4), after which the message data of the page designated by the variable n in the message board program data as received and stored is displayed on the display section 17 (step B5).

Since the message board program data has the same structure as the ordinary program data (e.g. weather forecasting program data and traffic information program data), the page is displayed irrespective of whether or not the message board program data is directed to the user. Therefore, the user can view the message data directed to other users. Needless to say, it is possible to employ a structure for causing only the message data directed to the user himself/herself to be displayed. In the case of message data with ID, that ID is not displayed, and only its message portion is displayed.

Next, it is determined whether the message data as displayed has ID (step B6). When it has ID, determination is performed as to whether the ID is that assigned to the FM radio receiver 1b (to 1d) stored in the ROM card 19 (step B7).

Only when it is determined that the displayed message data has ID and that the ID is the one assigned to the FM radio receiver 1b (to 1d), the alarm section 16 is driven so as to sound an alarm, and the user is alerted that the message data is directed to him/her, in such a manner that the message data is displayed in reverse video (step B8).

When it is determined in step B6 that the displayed message data has no ID, or when the displayed message data has ID but the ID is determined not to be the one assigned to the user in step B7, the alerting operation of step B8 is not conducted, and the flow of the processing advances to step B9.

Next, it is determined whether a page flipping key of the key input section 18 which is used for displaying the rest of the message data is operated (step B9). When it is determined in step B9 that the page flipping key is not operated, then it is determined whether the message displaying operation should be ended (step B10), by determining whether no keys are operated at the key input section 18 during a predetermined period of time, which is 30 seconds, for example, or by determining whether a key such as a reset key, a mode canceling key or a menu display key on the key input section 18 is operated. When it is determined in step B10 that the message displaying operation should not be ended, the flow of the processing returns to step A9, the determining operations of steps B9 and B10 are repeated.

When it is determined in step B9 that the page flipping key on the key input section 18 is operated, the aforementioned variable n is updated to “+1” (step B11), after which it is determined whether the value of the updated variable n for designating the page to be displayed exceeds the total page number in the program data header shown in FIG. 15A (step B12). When it is determined in step B12 that the value of the variable n does not exceed the total page number, the flow of the processing returns to step B5, and the message data of the next page is displayed.

When it is determined in step B12 that the value of the variable n exceeds the total page number, this indicates that the page flipping key has been operated during the display of the last page data included in the message board program data. In this case, the variable n is reset at the initial value “1” in order to display the message data of the first page again (step B13), and thereafter the flow of the processing returns to step B5.

When it is determined in step B10 that the message displaying operation should be ended, in other words, when it is determined that no keys are operated at the key input section for the predetermined period of time which is 30 seconds, for example, or when it is determined that a key such as the reset key, the mode cancel key or the menu display key is operated, the message displaying operation is ended.

In the above embodiment, the service center 4 receives the paging number and the message data. However, the service center 4 may receive only the message data (e.g. an inquiry or a question to every user, recruitment, information on the object which a user desires to sell or buy, etc.) and can transmit the message data as the program data on the message board program, without affixing ID to the message data.

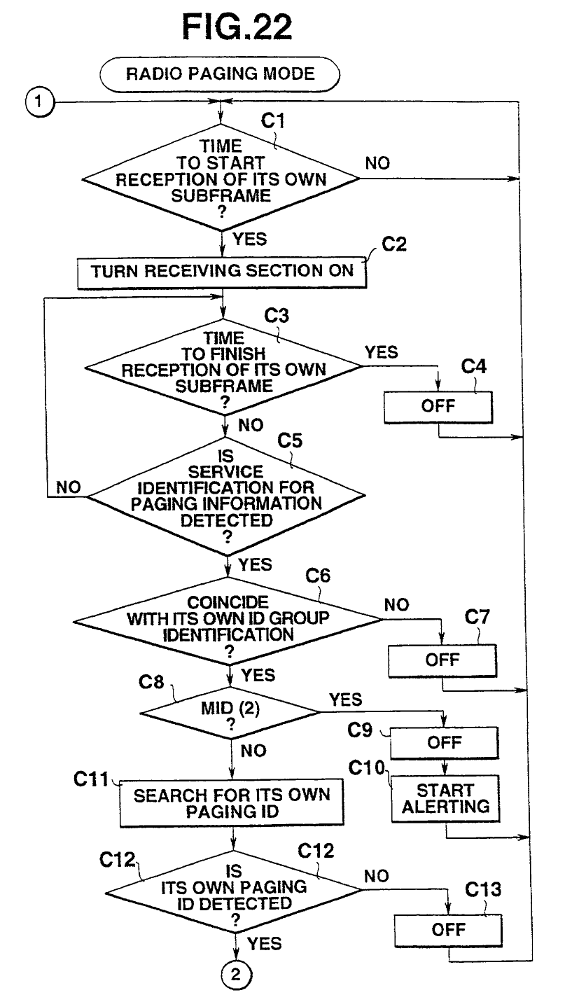

The processing shown in the flowcharts of FIGS. 22 to 25 will now be described.

The FM radio receivers 1b to 1d belong each to any one of the 16 groups divided in accordance with the lower four bits of their own ID codes. Each of the FM radio receivers 1b to 1d can intermittently receive the subframe assigned to the group to which it belongs.

The processing in the flowchart of FIG. 22 starts upon the designation of the radio paging mode.

When the processing starts, determination is performed as to whether it is time for the FM radio receiver 1b (to 1d) to start receiving a subframe of its own (step C1). When it is determined in step C1 that it is not time to start receiving such a subframe, step C1 is repeated, while the FM radio receiver 1b (to 1d) waits for the time to receive such a subframe. When it is determined in step C1 that it is time to start receiving it, the receiving section 12 and the multiplexed information reproducing section 4 are turned on as commanded by the CPU 15 (step C2).

Next, determination is performed as to whether it is time to end the reception of the subframe (step C3). When it is determined in step C3 that it is not time to end the reception of the subframe, it is determined whether the 4-bit service identification code in the prefix of FIG. 8B, which is included in a data packet in the subframe, is that for the paging information (step C5). When it is detected in step C5 that the 4-bit service identification is not that for the paging information, the flow of the processing returns to step C3, and steps C3 and C5 are repeated.

When it is determined in step C3 that it is time to end the reception of the subframe, the receiving section 12 and the multiplexed information reproducing section 14 are turned off as commanded by the CPU 15 (step C4). The flow of the processing returns to step C1, and the FM radio receiver 1b (to 1d) waits for the time to start receiving the next subframe of its own.

In this case, the receiving section 12 and the multiplexed information reproducing section 14 are turned on at the timing of the start of the reception of a subframe in the frame, for example, the subframe 7. When, however, the service identification code for the paging information is not detected in the subframe, the receiving section 12 and the multiplexed information reproducing section 14 are turned off at the timing of the end of the subframe.

When it is determined in step C5 that the service identification code for the paging information is detected in the subframe, a reference is immediately made to the paging data of FIG. 9 which is included in the data packet in the subframe, and it is determined whether the bit corresponding to the ID number included in the ID group identification code in the paging information of FIG. 12 represents the value “1” (step C6).

When it is determined in step C6 that the bit does not represent “1”, the receiving section 12 and the multiplexed information reproducing section 14 are immediately turned off (step C7). The flow of the processing returns to step C1, and the FM radio receiver 1b (to 1d) waits for the time to start receiving the next subframe of its own.

In this case, when the bit corresponding to the ID number included in the ID group identification code in the transmission format of the subframe 7 does not represent “1”, the receiving section 12 and the multiplexed information reproducing section 14 are immediately turned off.

When it is determined that the bit corresponding to the ID number in the ID group identification code represents “1” in step C6, then it is determined whether the received ID code (MID), i.e., the 2-bit identification code MID, represents in the decimal system the value “2” (equal to “10” in the binary system) which indicates the simultaneous paging (step C8).

When it is determined in step C8 that the MID represents “2”, the CPU 15 drives the alarm section 16 such that it sounds an alarm, thus starting alerting that the FM radio receivers 1b to 1d are simultaneously paged (step C10). The flow of the processing returns to step C1, and the FM radio receiver 1b (to 1d) waits for the time to start receiving the next subframe of its own.

The alerting operation initiated in step C10 is stopped after a predetermined period of time.

Employing this method, a message which is desired to be positively given to the user of the FM radio receiver 1b (to 1d), such as news or emergency information from the service center 4 or the FM broadcasting station 5, can be transmitted at the time of the simultaneous paging.

The pattern of the alarm sounded by the alarm section 16 in the case of the simultaneous paging may be different from that in the case of the ordinary individual paging.

When it is determined in step C8 that the MID does not represent “2”, the value of the MID is “0” which indicates the individual paging. Then, the FM radio receiver 1b (to 1d) searches individual paging ID No. 1 to No. N of FIG. 12 for its own paging ID (step C11).

Next, it is determined its own paging ID is detected as a result of the search (step C12). When it is determined that such paging ID is not detected, the receiving section 12 and the multiplexed information reproducing section 14 are immediately turned off (step C13). The flow of the processing returns to step C1, and the FM radio receiver 1b (to 1d) waits for the time to start receiving the next subframe of its own.

In this case, when such paging ID is not detected in the paging ID data group in the transmission format of the subframe 7, for example, the receiving section 12 and the multiplexed information reproducing section 14 are immediately turned off (step C13).

When it is determined in step C12 that such paging ID is detected, it is determined whether there is any unidentified page (step C14).

The presence/absence of an unidentified page is determined by whether there is any bit having no flag and indicating the presence of an unidentified page in a flag register (described later) in the CPU 15. The flag register is either in an initial reset state or in the state of storing flags of the number corresponding to the total page number. In step C14, the flag register is in the initial reset state, under which condition it is determined that there is an unidentified page. Next, the message board program is selected (step C16), and the reception and storage of its program data are initiated (step C17).

Prior to the reception of the message board program, the total page number in the program management data transmitted as 0 page data is detected, and a flag register for storing 1 bit per page is prepared in a register in the CPU 15.

After this, the presence/absence of an unidentified page is determined in accordance with whether there is any bit having no flag in the flag register (step C18). When the presence of an unidentified page is detected in step C18, it is determined whether the page data for 1 page of the message board program is completely received and stored (step C19).

When it is determined in step C19 that the page data for 1 page is not completely received and stored, the determining operation of step C19 is repeated, and the FM radio receiver 1b (to 1d) waits until the page data for 1 page of the message board program is completely stored.

In the case where the page data receiving and storing operations are initiated from the midst of the page data on the message board program, the total page number is unknown until the 0 page program management data is received. Under this condition, it is determined in step C18 that there is an unidentified page, until the flag register is set in the register.

When it is determined in step C19 that the page data for 1 page is completely received and stored, a reference is made to the flag register, and determination is performed as to whether a confirmation flag is set in the bit corresponding to the page (step C20). When it is determined in step C20 that the confirmation flag is set therein, the flow of the processing returns to step C19.

When it is determined in step C20 that the confirmation flag is not set therein, determination is performed as to whether the page data corresponding to the flag is the message data with ID shown in FIG. 17 (step C21). When it is determined in step C21 that the page data is the message data with the ID, then it is determined whether the ID coincides with that assigned to the FM radio receiver 1b (to 1d) and stored in the ROM card 19 (step C22).

When it is determined that the page data as received and stored in step C21 is not the message data with the ID, or when the ID in the message data as received and stored in step C22 does not coincide with the assigned ID, the processing advances to step C25.

When it is determined in step C22 that the ID in the message data received and stored in step C17 coincides with the assigned ID, this indicates that the message data is directed to the FM radio receiver 1b (to 1d) itself. In this case, a message in the message data is stored in that memory area of the received data memory 21 in which the message data directed to the FM radio receiver 1b (to 1d) is to be stored (step C23). Then, the alarm section 16 is driven to sound an alarm, and the message data directed to the FM radio receiver 1b (to 1d) is displayed on the display section 17, thus alerting that the FM radio receiver 1b (to 1d) is individually paged (step C24).

In step C25, the flag is set in the bit position within the flag register which position corresponds to the page. Thereafter, the flow of the processing returns to step C18.

The alarming operation initiated in step C10 is stopped after a predetermined period of time.

The operations of steps C18 to C25 are repeated, and when a flag is set in that bit position in the flag register which corresponds to the preceding page, it is determined in step C18 that there is no unidentified page. In this case, the receiving section 12 and the multiplexed information reproducing section 14 are turned off. The flow of the processing returns to step C1, and the FM radio receivers 1b (to 1d) waits for the time to start receiving the next subframe of its own.

In the process of the reexecution of the processing from step C1, when it is determined in step C12 that the ID assigned to the FM radio receiver 1b (to 1d) is detected while the same paging data is being transmitted a number of times in the same transmission period shown in FIG. 18, this means that a flag has already been set in the bit position corresponding to the preceding page. Under this condition, it is determined in step C 15 that there is no unidentified page. As a result, the receiving section 12 and the multiplexed information reproducing section 14 are turned off (step C15), and the flow of the processing returns to step C1. This prevents the processing from being unnecessarily repeated when the same paging data is transmitted a number of times.

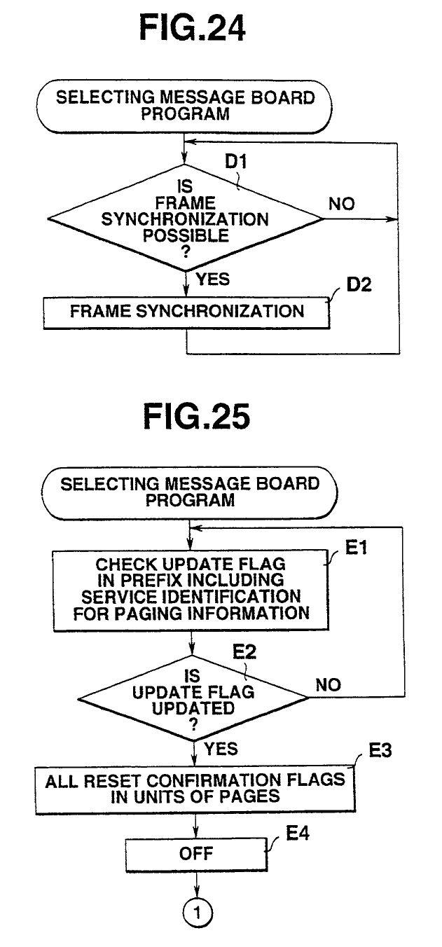

The message board program is selected in step C16, the reception and storage of its program data are initiated in step C17, and the receiving and storing operations are continued with steps C18 to C25 being repeated. Meanwhile, the CPU 15 executes the processing shown in the flow charts of FIGS. 24 and 25.

In the processing shown in the flowchart of FIG. 24, in consideration of bad conditions of received radio waves, it is determined whether the synchronization of a frame in received data can be performed, by detecting whether the level of a received signal is not less than a predetermined value (step D1). Step D1 is repeated while it is being determined that the frame synchronization cannot be performed. The frame synchronization is performed when it is determined in step D1 that the frame synchronization can be performed (step D2).

The frame synchronization in step D2 is performed by detecting a 16-bit BIC affixed to the head of each block with reference to the bit patterns of the BICs shown in FIG. 7, and by detecting the timing of the end of a frame or the timing of the start of a new frame in accordance with a variation occurring in the BIC as shown in FIG. 5.

The processing shown in the flow chart of FIG. 25 is executed prior to the receiving operation which is performed after step C16 of selecting the message board program. First, the update flag in the prefix whose service identification code is that for the paging information is checked in each of the data packets in all subframes as received (step E1). Next, the end of one transmission period which is, for example, 15 minutes as shown in FIG. 18, is detected in accordance with whether the update flag is updated (step E2).

When it is determined in step E2 that the update flag is not updated and hence the transmission period is not over, the flow of the processing returns to step E1. In other words, steps E1 and E2 are repeated in the transmission period. This is because the same paging ID is repeatedly transmitted including the same update flag.

When it is determined in step E2 that the update flag is updated and the transmission period is over, confirmation flags set in units of pages in the flag register in the CPU 15 are all reset (step E3), and the receiving section 12 and the multiplexed information reproducing section 14 are turned off (step E4), and the flow of the processing returns to the C1.

In step E1, the update flags of all subframes are checked. However, the present invention is not limited thereto, and only the update flag in any one of the subframes, for example, the subframe assigned to the FM radio receiver 1b (to 1d), may be checked.

Moreover, in step E1, the update flag in the prefix whose service identification code is that for the paging information is checked. However, since also the message board program data is repeatedly transmitted in one transmission period, either a program content update flag in the program data header or a page content update flag in the page data header may be checked.

Further, in FIG. 25, the end of one transmission period is detected upon the updating of the update flag in the prefix as shown in steps E1 and E2. However, it may be continually checked whether the paging ID of the FM radio receiver 1b (to 1d) is included in a subframe assigned thereto, and the processing may advance to step E3 at the time it becomes impossible to detect the paging ID.

In the case where the paging ID is still detected even though one transmission period is over and the subsequent transmission period begins, the receiving section 12 may not be turned off in step E4, and the reception of the message board program can be continued. Even in this case, however, the flag register resetting operation of step E3 needs to be assuredly performed.

Thus, if the FM receiver 1b (to 1d) detects the paging ID assigned thereto while it is performing the intermittent reception, then the receiver starts the continuous reception. If the FM receiver 1b (to 1d) receives and stores the message data directed thereto while the message board program is being selected, then the receiver performs the intermittent reception again. All of the above operations can be automatized by employing the processing shown in FIGS. 22 to 25. Accordingly, the message data directed to the FM radio receiver 1b (to 1d) is assuredly received and stored, and a waste of electric power is prevented so that the power of a battery for use in a portable device can be used with high efficiency.

Moreover, the synchronization of the frame data is constantly performed while the message data is being received. This enables the standby timing when performing the next and subsequent intermittent receiving operations to be maintained accurately, allowing the paging data directed to the user himself/herself to be assuredly detected all the time.

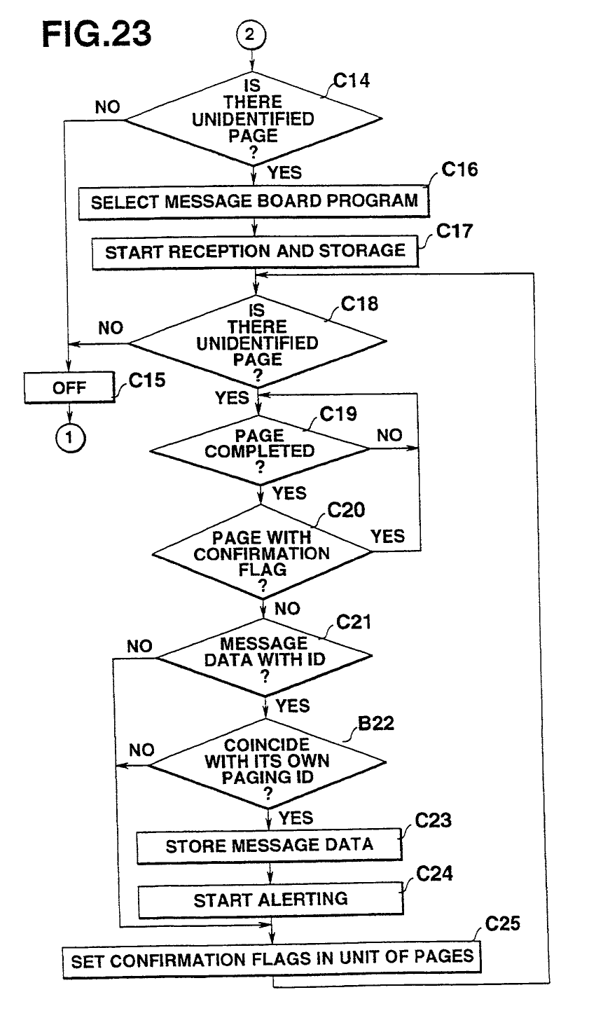

The paging ID for the simultaneous paging may be stored in advance in the ROM card 19 or the like so that the alerting operation explained with reference to FIG. 21 or 23 can be performed also in the case of the simultaneous paging.

Furthermore, in the processing shown in FIGS. 22 to 25, the alerting operation may be performed at the time of the detection of the individual paging ID in step C12, in affixation to or in place of the alerting operation in step C24.

Moreover, at the time the reception and storage of the message data directed to the FM radio receiver 1b (to 1d) itself are finished in the processing shown in FIGS. 22 to 25, the receiving section 12 and the multiplexed information reproducing section 14 may be turned off, even though there is an unidentified page.

Further, in the processing shown in FIGS. 22 to 25, the receiving section 12 and the multiplexed information reproducing section 14 may be turned off at the time the reception and the storage of the message data directed to the FM radio receiver 1b (to 1d) are finished, or at the time the reception and storage of all page data of the message board program are completed, and the receiving section 12 and the multiplexed information reproducing section 14 can be maintained completely in the OFF state until the next transmission period begins, if the lengths of the transmission periods are not variable but are fixed as shown in FIG. 18. This results in the battery power to be further saved.

Furthermore, according to the processing shown in FIGS. 22 to 25, in the flag register of the CPU 15, a flag can be set also in the bit corresponding to a page displayed as a result of the user selecting the message board program by manually operating the key input section 18. This prevents the alerting operation from being performed with respect to an identified page (the message addressed to the user himself/herself).

Similarly, according to the processing shown in FIG. 21, in the flag register of the CPU 15, a flag can be set in the bit corresponding to a page displayed upon the user's key operation, in order to prevent the alerting operation from being performed with respect to an identified page (the message directed to the user) for which a flag has already been set.

A program for executing each of the operations shown in the flow charts of FIGS. 19, 21 and 22 to 25 is stored in the ROM card 19 which is a recording medium as described previously, in the form of a program code which the CPU 15 can read.

Moreover, according to the above embodiment, the receiving section 12 and the multiplexed information reproducing section 14 are turned off at the time of the intermittent reception. However, only one of the receiving section 12 and the multiplexed information reproducing section 14 may be turned off.

In the above embodiment, the present invention is applied to the FM telecast broadcasting system. However, the present invention is not limited thereto, and can be adopted also for broadcasting radio waves such as those of a television telecast broadcasting system, insofar as it is possible to transmit various kinds of program data.

Various modifications of the present invention can be derived without departing the scope of the present invention.

1. A broadcasting apparatus for broadcasting a plurality of kinds of program information, comprising:
first broadcasting means for broadcasting paging ID information representing paging ID of a broadcast receiver to be paged; and
second broadcasting means for broadcasting, as at least one of said plurality of kinds of program information, message information directed to said broadcast receiver to be paged.

2. The broadcasting apparatus according to claim 1, further comprising information affixing means for affixing said paging ID information to said message information, wherein said second broadcasting means broadcasts said message information to which said paging ID information is affixed.

3. The broadcasting apparatus according to claim 1, wherein said first broadcasting means broadcasts said paging ID information in a predetermined period assigned to said broadcast receiver to be paged.

4. The broadcasting apparatus according to claim 3, wherein said first broadcasting means broadcasts group information for designating broadcast receivers to be paged including said broadcast receiver, before broadcasting said paging ID information.

5. The broadcasting apparatus according to claim 1, wherein said paging ID information is individual paging ID information for individually paging said broadcast receiver.

6. The broadcasting apparatus according to claim 1, wherein said paging ID information is simultaneous paging ID information for simultaneously paging a plurality of broadcast receivers.

7. The broadcasting apparatus according to claim 1, wherein said first and second broadcasting means respectively broadcast said paging ID information and said message information by multiplexing said paging ID information and said message information on FM broadcasting radio waves.

8. A broadcasting apparatus for broadcasting a plurality of kinds of program information, comprising:
information affixing means for affixing paging ID information representing paging ID of a broadcasting receiver to be paged to message information directed to said broadcasting receiver; and
broadcasting means for broadcasting, as one of said plurality of kinds of program information, said message information to which said paging ID information is affixed to said message information by said information affixing means.

9. A broadcast receiver for receiving and displaying a plurality of kinds of program information as broadcasting programs, comprising:
program selecting means for selecting a desired one of said plurality of kinds of program information;
display means for displaying the program information selected by said program selecting means;
receiving means for receiving broadcasted paging ID information;
determining means for determining whether said paging ID information received by said receiving means represents the paging ID of said broadcast receiver; and
paging alarm generating means for generating a paging alarm when said determining means determines that the paging ID information received by said receiving means represents the paging ID of said broadcast receiver;
wherein a user selects, by said program selecting means, a program on which message information directed to said broadcast receiver is broadcasted, and views the message information displayed on said display means, to thereby obtain the message information directed to said broadcast receiver.

10. The broadcast receiver according to claim 9, wherein the paging ID information is affixed to said message information, and said broadcast receiver further comprises alerting means for alerting that said message information is directed to said broadcast receiver when the paging ID information affixed to the message information displayed on said display means represents the paging ID of said broadcast receiver.

11. The broadcast receiver according to claim 9, wherein said receiving means executes an intermittent receiving opreration so as to receive the paging ID information in at least one of predetermined periods.

12. The broadcast receiver according to claim 11, wherein said receiving means receives group information;
said determining means determines whether there is a possibility that said broadcast receiver is paged, in accordance with said group information; and
when said determining means determines that there is a possibility that said broadcast receiver is paged, said determining means determines whether the paging ID information received by said receiving means is said paging ID information representing the paging ID of said broadcast receiver.

13. The broadcast receiver according to claim 12, wherein said broadcast receiver further comprising:
electricity supplying means for supplying electricity to said receiving means; and
electricity control means for turning off the supply of electricity from said electricity supplying means to said receiving means when said determining means determines that there is not a possibility that said broadcast receiver is paged.

14. The broadcast receiver according to claim 9, further comprising program selection control means for causing said program selecting means to select the program on which the message information directed to said broadcast receiver is broadcasted, when said determining means determines that the paging ID information received by said receiving means is said paging ID information representing the paging ID of said broadcast receiver.

15. The broadcast receiver according to claim 14, further comprising display control means for causing said display means to diseplay the message information directed to said broadcast receiver and which is broadcasted on the program selected by said program selecting means.

16. The broadast receiver according to claim 15, wherein the paging ID information is affixed to said message information, and said display control means causes said display means to display said message information directed to said broadcast receiver in accordance with said paging ID information affixed to said message information.

17. The broadcast receiver according to claim 9, wherein said paging ID information is individual paging ID information for individually paging said broadcast receiver.

18. The broadcast receiver according to claim 9, wherein said paging ID information is simultaneous paging information for simultaneously paging a plurality of broadcast receivers.

19. The broadcast receiver according to claim 9, wherein said receiving means receives the paging ID information and the message information which is broadcasted with being multiplexed on FM broadcasting radio waves.

20. A broadcast receiver for receiving and displaying a plurality of kinds of program information, comprising:
program selecting means for selecting a desired one of said plurality of kinds of program information;
display means for displaying the program information selected by said program selecting means;
receiving means for receiving broadcasted paging ID information;
determining means for determining whether the paging ID information received by said receiving means represents paging ID of said broadcast receiver; and
obtaining means for obtaining message information directed to said broadcast receiver, from program information of a program on which the message information directed to said broadcast receiver is broadcasted.

21. The broadcast receiver according to claim 20, wherein the paging ID information is affixed to said message information, and said obtaining means obtains said message information in accordance with said paging ID information affixed to said message information.

22. The broadcast receiver according to claim 20, wherein said receiving means executes an intermittent receiving operation so as to receive the paging ID information in at least one of the predetermined periods.

23. The broadcast receiver according to claim 22, wherein when said determining means determines that the paging ID information received by said receiving means is said paging ID information representing the paging ID of said broadcast receiver, said obtaining means causes said receiving means to receive information continuously in order to obtain the message information directed to said broadcast receiver.

24. The broadcast receiver according to claim 23, wherein said obtaining means causes said receiving means to receive said paging ID information intermittently, after said obtaining means obtains the message information directed to said broadcast receiver.

25. The broadcast receiver according to claim 20, further comprising paging alarm generating means for generating a paging alarm in one of cases where said determining means determines that the paging ID information affixed to said message information represents the paging ID of said broadcast receiver and where said obtaining means obtains the message information directed to said broadcast receiver.

26. A broadcast receiver for receiving and displaying a plurality of kinds of program information, comprising:
program selecting means for selecting a desired one of said plurality of kinds of program information;
display means for displaying the program information selected by said program selecting means;
determining means for determining whether message information displayed on said display means is directed to said broadcast receiver in accordance with the paging ID information affixed to the message information, when said program selecting means selects a program information on which said message information is broadcasted with paging ID information being affixed to said message information; and
alerting means for alerting that said message information is directed to said broadcast receiver when said determining means determines that said message information is directed to said broadcast receiver.

27. A broadcast receiver for receiving and displaying a plurality of kinds of program information, comprising:
program selecting means for selecting a desired one of said plurality of kinds of program information;
display means for displaying the program information selected by said program selecting means;
obtaining means for obtaining message information from the program information of a program on which said message information is broadcasted with paging ID information being affixed to said message information, said message information being directed to said broadcast receiver.

28. A broadcasting system comprising a broadcasting apparatus for broadcasting a plurality of kinds of program information and a plurality of broadcast receivers for receiving and displaying the program information broadcasted from said broadcasting apparatus,
said broadcasting apparatus comprising:
first broadcasting means for broadcasting paging ID information; and
second broadcasting means for broadcasting, as at least one of said plurality of kinds of program information, message information directed to at least one of said plurality of broadcast receivers;
each of said broadcast receiver comprising:
program selecting means for selecting a desired one of said plurality of kinds of program information broadcasted from said broadcasting apparatus;
display means for displaying the program information selected by said program information selecting means;
receiving means for receiving the paging ID information broadcasted from said broadcasting apparatus;
determining means for determining whether said paging ID information received by said receiving means represents the paging ID of each said broadcast receiver; and
paging alarm generating means for generating a paging alarm when said determining means determines that the paging ID information received by said receiving means represents the paging ID of each said broadcast receiver;
wherein a user selects, by said program selecting means, a program on which message information directed to said broadcast receiver is broadcasted, and views the message information displayed on said display means, to thereby obtain message information directed to each said broadcast receiver in the message information.

29. A broadcasting system comprising a broadcasting apparatus for broadcasting a plurality of kinds of program information and a plurality of broadcast receivers for receiving and displaying the program information broadcasted from said broadcasting apparatus,
said broadcasting apparatus comprising:
first broadcasting means for broadcasting paging ID information; and
second broadcasting means for broadcasting, as at least one of said plurality of kinds of program information, message information directed to at least one of said plurality of broadcast receivers;
each of said broadcast receiver comprising:
program selecting means for selecting a desired one of said plurality of kinds of program information broadcasted from said broadcasting apparatus;
display means for displaying the program information selected by said program information selecting means;
receiving means for receiving the broadcasted paging ID information;
determining means for determining whether the paging ID information received by said receiving means represents paging ID of each said broadcast receiver; and
obtaining means for obtaining message information directed to each said broadcast receiver in the message information, from the program information of a program on which the message information is broadcasted, when said determining means determines that the paging ID information received by said receiving means represents the paging ID of said broadcast receiver.

30. A broadcast paging method comprising:
a first step of broadcasting paging ID information representing paging ID of a broadcast receiver to be paged;
a second step of broadcasting, at least one of a plurality of kinds of program information, message information directed to said broadcast receiver to be paged.

31. A broadcasting paging method comprising steps of:
affixing paging ID information representing paging ID of a broadcast receiver to be paged to message information directed to said broadcast receiver; and
broadcasting, as at least one of a plurality of kinds of program information, said message information to which said paging ID information is affixed.

32. A broadcast paging receiving method for use in a broadcast receiver comprising steps of:
receiving broadcasted paging ID information;
determining whether the received paging ID information represents the paging ID of said broadcast receiver;
generating a paging alarm when it is determined that the received paging ID information represents the paging ID of said broadcast receiver;
selecting a program on which message information directed to said broadcast receiver is broadcasted, from a plurality of kinds of programs which are broadcasted; and
displaying program information of the selected program on which the message information directed to said broadcast receiver is broadcasted.

33. A broadcast paging receiving method for use in a broadcast receiver comprising steps of:
receiving broadcasted paging ID information;
determining whether the received paging ID information represents the paging ID of said broadcast receiver; and
obtaining message information directed to said broadcast receiver, from program information of a program on which the message information directed to said broadcast receiver is broadcasted.

34. A broadcast paging receiving method comprising the steps of:
selecting, from a plurality of kinds of programs which are broadcasted, a program on which message information is broadcasted with paging ID information being affixed to said message information, said message information being directed to a broadcast receiver to be paged;
displaying program information of the selected program on which the message information directed to said broadcasted receiver is broadcasted;
determining whether the displayed message information is directed to said broadcast receiver, in accordance with the paging ID information affixed to the message information; and
alerting that the displayed message information is directed to said broadcast receiver, when it is determined that the displayed message information is directed to said broadcast receiver.

35. A broadcast paging receiving method comprising steps of:
determining whether paging ID information representing paging ID of a broadcast receiver is included in program information of a program on which message information is broadcasted with the paging ID information being affixed to said message information; and
obtaining the message information to which the paging ID information is affixed, when it is determined that the paging ID information is included in said program information.
